(19) United States
(12) Patent Application Publication
(10) Pub. No.: US 2007/0274565 A1
(43) Pub. Date: Nov. 29, 2007

(54) METHODS OF IMPLANTING WIRELESS DEVICE WITHIN AN ANATOMICAL CAVITY DURING A SURGICAL PROCEDURE

(75) Inventor: Abraham Penner, Tel Aviv (IL)

Correspondence Address: Vista IP Law Group LLP, 2040 MAIN STREET, 9TH FLOOR, IRVINE, CA, 92614, US

(73) Assignee: REMON MEDICAL TECHNOLOGIES LTD., Caesarea, IL (US)

(21) Appl. No.: 11/750,972

(22) Filed: May 18, 2007

Related U.S. Application Data
(60) Provisional application No. 60/803,023, filed on May 23, 2006.

(51) Int. Cl. G06K 9/00

(52) U.S. Cl. 382/103

(57) ABSTRACT

A method of implanting a wireless device within a patient is provided. The wireless device is capable of wirelessly communicating within another device (e.g., an external device) using, e.g., acoustic energy, electromagnetic energy, or magnetic energy. The method comprises forming a surgical opening within the patient to expose an anatomical structure, and repairing or replacing the anatomical structure. The method further comprises introducing the wireless device into an anatomical cavity (e.g., a blood vessel or a heart chamber) via the surgical opening. The method further comprises affixing the wireless device within the anatomical cavity (e.g., using the securing means set forth above), wherein the entire device is contained within the anatomical cavity.

### CROSS-REFERENCE TO RELATED APPLICATIONS

This application claims the benefit under 35 U.S.C. § 119 to U.S. Provisional Application Ser. No. 60/803,023, filed on May 23, 2006, which is incorporated herein by reference.

### BACKGROUND OF THE INVENTION

A surgical procedure can be performed on a patient either to remove or repair a portion of the patient's body or to determine whether disease is present in the patient's body. One surgical procedure can be a surgical cardiac procedure, for example, one that involves coronary bypass grafting or a surgical valve replacement or repair. Some patients undergoing cardiac surgery are considered to be at high risk for the postoperative period and are kept under close observation for up to several weeks after surgery.

The monitored vital parameters of these patients include hemodynamic parameters, which are crucial in those patients suffering from cardiovascular disease. The most significant hemodynamic parameters monitored include left ventricle end diastolic pressure (LVEDP), pulmonary artery wedge pressure, pulmonary artery diastolic pressure (PAD), and cardiac output. Titration of some medication is restrictedly performed in the Intensive Care Unit (ICU), and the monitoring of these hemodynamic parameters serves as the feedback mechanism until the patient's condition stabilizes.

The hemodynamic parameters of a postoperative patient have traditionally been monitoring using a right heart catheter (RHC). The usage of a RHC poses several risks, however, with catheter infection being the most common complication since there is a clinical sepsis change of about 0.5%-1% per day of catheter use. In addition, the use of a RHC adds an additional invasive tube and an additional connection to the hospital monitoring setup. Also, an RHC cannot directly measure left side pressures and contractility, which can be of a high importance in heart disease patients.

It is known to implant sensors within a patient in order to monitor physiological parameters and wirelessly transmit the resulting diagnostic data to an external device, thereby obviating the need for chronic use of catheters or other tubes. For example, sensors or transducers may be located deep within the patient's body for monitoring a variety of properties, such as temperature, pressure, strain, fluid flow, chemical properties, electrical properties, magnetic properties, and the like. Some wireless devices may also be implanted to perform one or more therapeutic functions, such as drug delivery, defibrillation, electrical stimulation, and the like.

In cases where a device is to be fully implanted within an anatomical cavity, such as, e.g., a heart chamber, blood vessel, or anywhere along the alimentary canal, it is known to deliver such device via catheterization. Obviously, delivering an implant via catheterization has many advantages over delivering the implant via a surgical procedure. However, delivering an implant via catheterization does have some disadvantages and in, some cases, may be impractical.

For example, a catheterization procedure may limit the size of the implantable device. Typically, the implantation of a device having a size greater than that requiring a catheter size larger than 14F (approximately, 4.5 mm) requires surgical exposure of the access blood vessel in order to introduce such a large catheter into the patient. In many cases, the target blood vessel, heart chamber, or other bodily cavity in which the device is designed to be implanted can accommodate a far larger implant than can be delivered via a catheterization procedure. For example, the diameter of a pulmonary artery may range between 20-30 mm.

Thus, a catheterization procedure can only be practically used when the implantable device is small enough. However, due to power and communication requirements and cost factors, the size of an implantable device is typically large. For example, an implantable device that is designed to operate within a patient's body for years requires a source of energy. One option is to incorporate a built-in battery into the implantable device. Because this battery should have enough capacity to support the implantable device over its lifespan, the battery must be relatively large. As a result, the size of the implantable device may be too large to allow it to be delivered into the patient's body via a catheterization procedure.

Recently, the Endosure™ device (manufactured by CarioMEMS, Inc., located in Atlanta, Ga.) and the ImPressure™ device (manufactured by Remon Medical Technologies, located in Caesarea, Israel) have demonstrated the ability to intravascularly deliver a miniature, wireless, fully implanted device to monitor pressure within an artery. Both devices are designed to be used as chronic implants, thereby allowing treatment optimization of chronic diseases, such as congestive heart failure or the detection of ischemia in patients suffering from coronary artery disease or heart valve disease.

However, the ImPressure™ device utilizes acoustic energy as an efficient means of wirelessly communicating from deep inside the patient's body, requiring the external communications device to be in contact with the skin of the patient. In addition, to ensure that its profile is small enough to allow delivery through a catheter, the ImPressure™ device requires miniaturized batteries, which are relatively expensive, thereby driving up the total cost of the devices. The Endosure™ device is a passive device that includes an electrical LC circuit in which the capacitance C changes according to pressure sensed by a variable capacitance pressure sensor. By interrogating the device using a RF field induced by an external antenna, the resonant frequency of the device can detected. Because the induction L of the circuit is known, the capacitance C, and thus, the sensed pressure, can be determined from the detected resonant frequency. However, the external antenna needed to interrogate the Endosure™ is relatively large (about the size of a tennis racket), is thus not easily portable.

Notwithstanding the foregoing, catheterization may be limited by the accessible blood vessel, and anchoring the sensor can be challenging with a significant risk of sensor migration, perforation, or protrusion. A catheterization procedure performed specifically for implanting a device also exposes the patient to additional risks, including infection, damage to the vessel, damage to heart valves, kidney damage due to exposure to contrast agent, and radiation exposure.

There, thus, is a need to provide an improved method for implanting wireless devices within a patient.

### SUMMARY OF THE INVENTION

In accordance with a first aspect of the present inventions, a method of implanting a physiological sensing device within a patient is provided. The sensing device is capable of wirelessly communicating within another device (e.g., an external device or a second implantable device) using, e.g., acoustic energy, electromagnetic energy, or magnetic energy. The sensing device can be, e.g., a pressure sensor that measures a full pressure waveform within the blood vessel. The sensing device, however, can include other types, such as, e.g., an accelerometer, a wall motion sensor, a flow sensor, temperature sensor, oxygen sensor, glucose sensor, coagulation sensor, an electrical activity (e.g. ECG) sensor or pH sensor. The sensing device may optionally comprise a processor for processing physiological information sensed by the sensing device. For example, the processor can be configured for estimated one or more of blood velocity, stroke volume, and cardiac output.

The method comprises forming a surgical opening within the patient to expose an anatomical structure, and repairing or replacing an anatomical structure or a portion thereof. For example, if the anatomical structure is a heart or a portion thereof, the repairing or replacing may comprise performing one or more of a coronary artery bypass graft installation, heart valve repair, heart valve replacement, surgical ventricular restoration, ventricular assist device implantation, and heart transplant.

The method further comprises introducing the sensing device into a blood vessel via the surgical opening. In one method, the blood vessel is a pulmonary artery, although, depending on the surgical procedure, the sensing device can be introduced into other blood vessels, such as a vena cava, pulmonary vein, coronary sinus, aorta, sub-clavian artery, iliac artery, and carotid artery. The sensing device may be introduced into the blood vessel by forming an opening through the wall of the blood vessel, and inserting the sensing device through the wall opening into the lumen of the blood vessel. The sensing device may also be introduced into the blood vessel by introducing a cannula with the sensing device through the vessel wall (either through an already formed opening or by creating an opening), and releasing the sensing device from the cannula within the lumen of the blood vessel. The sensing device may also be introduced into the blood vessel without forming an opening within the wall of the blood vessel. For example, the sensing device can be introduced through an ostium of the blood vessel, e.g., from a chamber of the heart.

The method further comprises affixing the sensing device within the blood vessel, wherein the entire sensing device is contained within the blood vessel. The sensing device can be affixed within the blood vessel using any suitable means, such as a suture, barb, staple, or screw. In an optional method, the implanted sensing device senses a physiological parameter to monitor the anatomical structure.

In accordance with a second aspect of the present inventions, another method of implanting a wireless device within a patient is provided. The wireless device is capable of wirelessly communicating within another device (e.g., an external device) using, e.g., acoustic energy, electromagnetic energy, or magnetic energy. The wireless device may be, e.g., a sensing device, such as that described above, or a therapeutic device.

The method comprises forming a surgical opening within the patient to expose an anatomical structure, and repairing or replacing the anatomical structure. The method further comprises introducing the wireless device into an anatomical cavity (e.g., a blood vessel or a heart chamber) via the surgical opening. The wireless device may be introduced into the anatomical cavity by forming an opening through the wall surrounding the anatomical cavity, and inserting the sensing device through the wall opening into the cavity. The wireless device may also be introduced into the anatomical cavity by introducing a cannula with the wireless device through the wall (either through an already formed opening or by creating an opening), and releasing the wireless device from the cannula within the cavity. The method further comprises affixing the wireless device within the anatomical cavity (e.g., using the securing means set forth above), wherein the entire device is contained within the anatomical cavity.

In accordance with a third aspect of the present inventions, still another method of implanting a device within a patient is provided. The wireless device is capable of wirelessly communicating within another device (e.g., an external device) using, e.g., acoustic energy, electromagnetic energy, or magnetic energy. The wireless device may be, e.g., a sensing device, such as that described above, or a therapeutic device.

The method comprises forming an opening within the patient to expose a heart of the patient, and repairing or replacing an anatomical structure of the heart (e.g., by performing one or more of a coronary artery bypass graft installation, heart valve repair, heart valve replacement, surgical ventricular restoration, ventricular assist device implantation, and heart transplant). The method further comprises introducing the wireless device through the opening into a blood vessel of the patient (e.g., a pulmonary artery), such as in the manner described above, and affixing the wireless device within the anatomical cavity (e.g., using the securing means set forth above), wherein the entire device is contained within the anatomical cavity. If the wireless device is introduced within the blood vessel from a heart chamber, the method may optionally comprise forming an opening within the heart to access the chamber, and introducing the wireless device into the chamber of the heart via the heart opening. In another optional method, the heart may be arrested and blood may be conveyed between the chamber of the arrested heart and a machine via the heart opening.

Other and further aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a block diagram of an implantable system constructed in accordance with one embodiment of the present inventions;

FIG. 2 is a cross-sectional view of an implantable wireless device used in the implantable system of FIG. 1;

FIGS. 3A-3E are views illustrating a method of implanting the wireless device of FIG. 2 into the pulmonary artery of a patient;

FIGS. 4A-4D are views illustrating another method of implanting the wireless device of FIG. 2 into the pulmonary artery of a patient;

FIG. 5 is a perspective view of a clamp used to isolate a lateral region of a pulmonary artery from blood flow;

FIGS. 6A-6F are cross-sectional views illustrating different manners for affixing the wireless device of FIG. 2 to a vessel wall of a patient; and

FIGS. 7A-7C are views illustrating still another method of implanting the wireless device of FIG. 2 into the pulmonary artery of a patient.

### DETAILED DESCRIPTION OF EMBODIMENTS

Referring to FIG. 1, an implantable system 10 constructed in accordance with one embodiment of the present inventions will now be described. The implantable system 10 generally comprises an implantable sensing device 12, which is configured for being implanted within and acquiring physiological information from a patient, and an external device 14 configured for wirelessly interacting with the sensing device 12. As will be described in further detail below, the sensing device 12 is designed to be implanted within an anatomical vessel (e.g., a pulmonary artery) of a patient during a surgical procedure performed to repair or replace an anatomical structure (e.g., a heart), so that a physiological parameter (e.g., blood pressure) can be measured to post-operatively monitor the patient.

In the illustrated embodiment, the external device 14 is a handheld battery operated unit. Because the sensing device 12 is intended to be implanted deep within the tissue of the patient, the external device 14 and sensing device 12 are designed to communicate with each other using acoustic energy (e.g., at a relatively low frequency of 40 KHz), and in particular, by transmitting and receiving acoustic energy through the tissue. Thus, the external device 14 may be placed in direct contact with the patient's skin to communicate with the implanted sensing device 12.

The external device 14 may transmit acoustic energy to control or operate the sensing device 12, and receive acoustic energy to acquire the sensed physiological information from the sensing device 12. For example, the external device 14 may activate and deactivate the sensing device 12 (i.e., alternately placing it in an “active mode” and “dormant mode”). The external device may also transmit acoustic energy to charge the sensing device 12.

Thus, the implanted sensing device 12 may be activated on demand by the external device 14, sample the intended physiological parameter, and wirelessly transmit the physiological information to the external device 14. The external device 14 may then process the physiological information. For example, if the measured physiological parameter is absolute pressure, the external device 14 may calculate a gauge blood pressure value by subtracting the barometric pressure (measured by a barometric pressure sensor on the external device 14 or received from a remote site) from the measured absolute pressure.

The external device 14 may include a memory (not shown) for storing the recorded and processed physiological information readings and a display (not shown) for conveying the readings to a healthcare worker. The external device 14 may be optionally configured such that it can be connected to a personal computer (PC)-based clinic to enable downloading of the sensed physiological information.

Further details describing means for acoustically communicating between implanted devices and external devices are set forth in U.S. Patent No. 7,024,248, which is expressly incorporated herein by reference. Alternatively, other forms of wireless communications, e.g., electromagnetic or magnetic, can be used to communicate between the sensing device 12 and the external device 14. Notably, because the sensing device 12 is designed to be implanted during a surgical procedure, its size can be larger, thereby enabling wireless communication through the deep tissue using these alternative communications means. In alternative embodiments, the sensing device 12 may wirelessly communicate with other implantable devices, as described in U.S. patent application Ser. No. 10/413,428, entitled “Apparatus and Methods Using Telemetry for Intrabody Communications,” which is expressly incorporated herein by reference.

It should be appreciated that the implantation of the sensing device 12 into a patient will obviate the need to post-operatively monitor critical parameters using a catheter or tube. For example, the sensing device 12 can be implanted within the pulmonary artery or the left or right branch thereof to measure the full pulmonary artery pressure waveform of the patient after being transferred from the ICU to a regular hospital ward and to monitor such patient for the recovery period (typically 4 weeks) after being discharged from the hospital. The pulmonary pressure waveform can then be used to estimate stroke volume and cardiac output. Thus, it can be appreciated that the need for a right heart catheter (RHC) to perform the same function may be obviated by the use of the sensing device 12. Since many patients undergoing cardiac surgery continue to suffer from chronic heart disease, such as congestive heart failure (CHF), the chronically implanted sensing device 12 may also aid in optimizing the treatment for CHF in years to come. In optional embodiments, the physiological information measured by the sensing device 12 can be used to optimize the performance of one or more implanted therapeutic devices, as described in U.S. patent application Ser. No. 11/373,005, entitled “A Body Attachable Unit in Wireless Communication with Implantable Devices,” which is expressly incorporated herein by reference.

The sensing device 12 may also be configured, such that it measures other physiological parameters. For example, the sensing device 12 may measure blood flow, temperature, oxygen level, glucose level, electrical impedance, pH, and the like. More than one sensing device 12 may be implanted within a blood vessel to monitor at least one physiological parameter. For example, simultaneous pressure measurement using diagnostic devices 12 that measure pressure may be spaced along the longitudinal axis within the lumen of the blood vessel, thereby allowing calculation of blood flow (cardiac output) and blood flow velocity.

The sensing device 12 may alternatively include a microphone for recording breathing sounds, which may be useful for diagnosis of diseases (e.g., detecting edema of congestive heart failure (CHF) patients, as described in U.S. Pat. No. 7,035,684, which is expressly incorporated herein by reference. The microphone may also be used to analyze the performance of mechanical and bio-prosthetic heart valves, including failure detection, hemodynamic analysis, and thrombus formation over the heart valve, as described in Lanning & Shandas, “Medical & Biological Engineering & Computing,” July 2003, Volume 41, issue 4, pp. 416-424. The microphone is preferably operated in the frequency range of 100 Hz-10 KHz, and more preferably in the frequency range of less than 1 KHz. In this case, the sensing device 12 may be implanted in any of the blood vessels close to the valve.

The sensing device 12 may also be implanted in the chambers of the heart. For example, in the case where the sensing device 12 measures pressure, it may be implanted within the left ventricle or the left atrium of the patient to monitor the left ventricle end diastolic pressure or its surrogates (e.g., pulmonary artery diastolic pressure or right atrium pressure). Monitoring this parameter for the long term can be extremely important for the optimal treatment of heart diseases. In the case where the sensing device 12 records sound, it may be secured close to the valve within the heart chambers, or be secured to the valve itself, so that the functioning of the valve can be analyzed. The sensing device 12 may be implanted proximally or distally to the valve, or two of the diagnostic devices 12 may be respectively implanted proximally and distally to the valve.

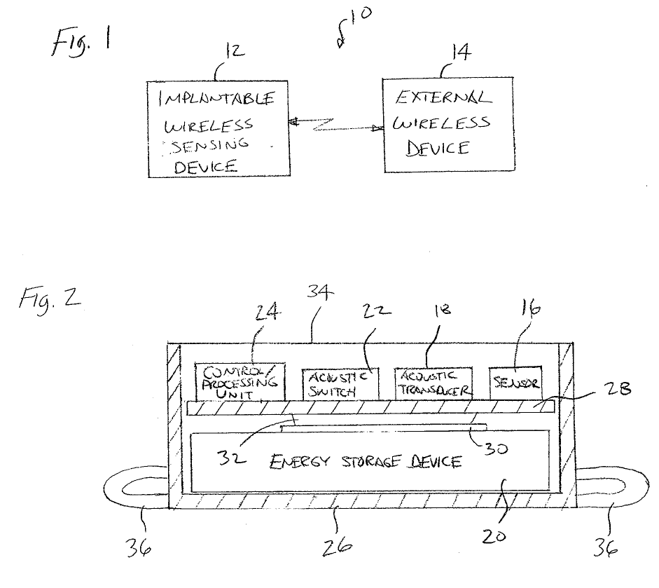

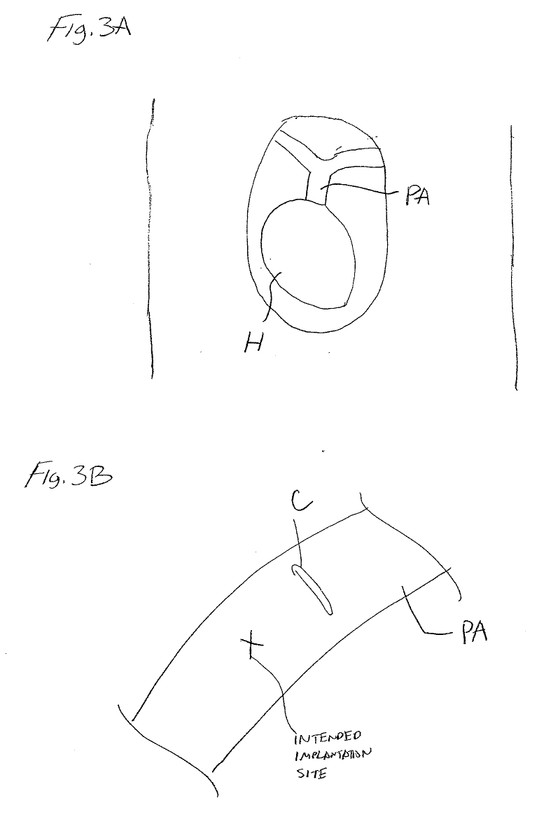

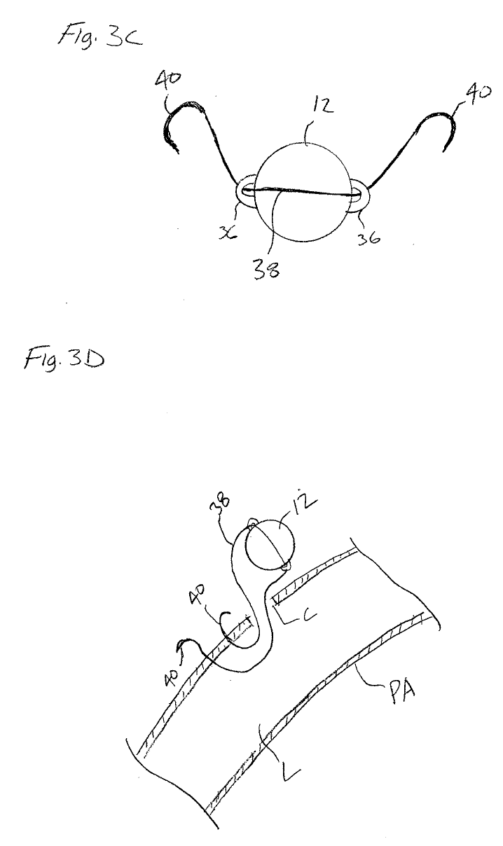

Having generally described the sensing device 12, its specific structure will now be described with reference to FIG. 2. In the illustrated embodiment, the sensing device 12 is a miniature disk-shaped module having a diameter of approximately 5.5 mm and a thickness of 3 mm. As previously discussed in the background of invention, a device that is larger than 4.5 mm is difficult to deliver into a patient via a catheterization procedure. However, because the sensing device 12 is intended to be implanted within the patient during a surgical procedure, the size of the sensing device 12 does not significantly hinder the delivery of the sensing device 12 into the patient.

The sensing device 12 comprises a plurality of components, including a sensor 16, acoustic transducer 18, energy storage device 20, acoustic switch 22, and control/processing unit 24, all housed within a casing 26. The casing 26 is composed of a suitable biocompatible material, such as titanium, and is hermetically sealed to isolate the components from the environment outside of the sensing device 12. Further details regarding the construction of casings for implantable devices are described in U.S. Pat. No. 6,764,446, which is expressly incorporated herein by reference. As shown in FIG. 2, the sensor 16, acoustic transducer 18, acoustic switch 22, and control/processing unit 24 are mounted on the front side of a printed circuit board 28.

The sensor 16 may be any desired biosensor that generates a signal proportional to a measured physiological parameter that may be processed and wirelessly transmitted from the control/processing unit 24 to the external device via the acoustic transducer 18. In the illustrated embodiment, the sensor 16 is preferably a pressure sensor, but may be any other suitable sensor capable of measuring physiological parameters, such as those previously set forth.

The acoustic transducer 18 includes one or more piezoelectric elements configured for transmitting and receiving acoustic signals. In particular, the acoustic transducer 18 generates an electrical signal proportional to the magnitude of acoustic energy received by the acoustic transducer 18, which electrical signal is conveyed to the control/processing unit 24. Similarly, the acoustic transducer 18 generates an acoustic signal proportional to the magnitude of the electrical energy conveyed from the control/processing unit 24 to the acoustic transducer 18. Further details regarding the construction of acoustic transducers for implantable devices are described in U.S. Pat. No. 6,140,740, which is expressly incorporated herein by reference.

The energy storage device 20 may be any of a variety of known devices, such as an energy exchanger, a battery and/or a capacitor. Preferably, the energy storage device 20 is capable of storing electrical energy substantially indefinitely unless actively discharged. In the illustrated embodiment, the energy storage device 20 is located adjacent the rear side of the printed circuit board 28. The energy storage device 20 includes a terminal 30 that contacts a corresponding terminal 32 on the printed circuit board 28, so that the energy storage device 20 can supply the remaining components with power.

The acoustic switch 22 is coupled between the energy storage device 20 and the control/processing unit 24 to minimize the standby current from the energy storage device 20, thereby significantly extending the operable life span of the sensing device 12. In particular, the acoustic switch 22 is activated upon acoustic excitation of the acoustic transducer 18 by an acoustic activation signal transmitted by the external device 14 to allow current flow from the energy storage device 20 to the control/processing unit 24. Thus, the acoustic switch 22 allows the sensing device 12 to operate in two modes, a “sleep” or “dormant” mode when the sensing device 12 is not in use, i.e., when the acoustic switch 22 is open and no electrical energy is delivered from the energy storage device 20 to the control/processing unit 24, and an “active” mode, when the acoustic switch 22 is closed and electrical energy is delivered from the energy storage device 20 to the control/processing unit 24. Further details regarding the construction and function of acoustic switches are disclosed in U.S. Pat. No. 6,628,989, which is expressly incorporated herein by reference.

Alternatively or optionally, the sensing device 12 may be configured as a passive device, as described in U.S. Pat. Nos. 5,704,352 and 6,855,115, or the sensing device 12 may be wirelessly charged by transferring energy (e.g., ultrasound, electromagnetic, or magnetic energy) from the external device to the sensing device 12, as described in U.S. Pat. No. 6,475,170, all of which are expressly incorporated herein by reference. In addition, the energy storage device 20 may be capable of being charged from an external source, and in particular, from acoustic energy transmitted to the sensing device 12 from the external device 14.

The control/processing unit 24 may include circuitry for activating or controlling the sensor 16 and for receiving signals from the sensor 16. In particular, under control of the control/processing unit 24, the physiological parameters may be measured and the resulting physiological information transmitted from the sensing device 12 to the external device 14 continuously or periodically until the sensing device 12 is deactivated, or for a fixed predetermined time, as will be appreciated by those skilled in the art.

The control/processing unit 24 may also include memory for storing information, e.g., data received from the sensor 16, and/or commands for use internally. The control/processing unit 24 may include an oscillator or other circuitry for wirelessly transmitting acoustic signals to the external device via the acoustic transducer 18, signal detection circuitry for wirelessly receiving acoustic signals from the external device via the acoustic transducer 18, and/or a processor for analyzing, interpreting, and/or processing the received signals. The control/processing unit 24 may include a processor for analyzing, interpreting, and/or processing the signals received by the sensor 16 or from the external device.

The casing 26 has at least one face 34 that is substantially flexible for transmitting pressure to the sensor 16 and acoustic transducer 18. The volume between the flexible face 34 and the printed circuit board 28 is preferably filled with an uncompressible liquid that is preferably chemically inert and has a low thermal expansion. The flexible face 34 of the casing 26 is preferably composed of a metal membrane with a thickness of 1-250 microns. The casing 26 further comprises a pair of eyelets 36 through which sutures can be threaded to facilitate affixation of the sensing device 12 within the patient, as will be described in further detail below.

Further details on the structure of a wireless device capable of sensing pressure can be found in U.S. patent application Ser. No. 09/888,272, entitled “Implantable Pressure Sensors and Methods for Making and Using Them,” which is expressly incorporated herein by reference.

Having described the function and structure of the implantable system 10, methods of implanting the sensing device 12 within a patient will now be described. These methods contemplate delivering the sensing device 12 as an adjunct to a surgical procedure for repair or placing an anatomical structure within the patient. In this manner, the same opening formed within the patient as a necessary step in the surgical procedure is used to deliver the sensing device 12 therethrough. Thus, even though the sensing device 12 may ultimately be implanted within a blood vessel leading one of ordinary skill in the art to believe that the means for delivery should be a catheterization procedure, the sensing device 12 will actually be delivered through the surgical opening and into the blood vessel. Thus, it can be appreciated that no additional access opening need be formed through the skin of the patient to implant the sensing device 12. In addition, because a catheterization procedure is not performed to effect implantation of the sensing device 12, the size of the sensing device 12 may be larger and will only be constrained by the size of the blood vessel in which the sensing device 12 is intended to be implanted.

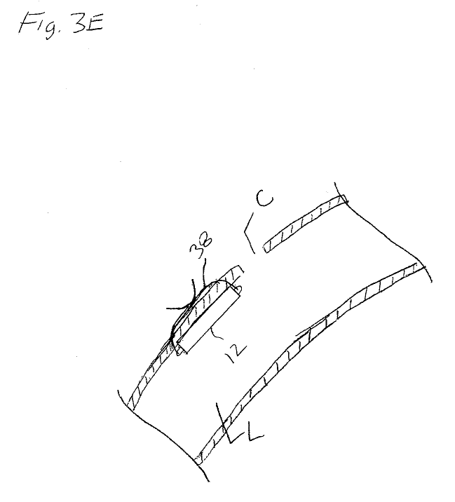

Referring now to FIGS. 3A-3F, one method of delivering the sensing device 12 into the pulmonary artery PA of a patient as an adjunct to performing surgery on the heart H of the patient will be described. First, a surgical opening is made through the patient's chest to expose the heart H, along with the pulmonary artery PA (FIG. 3A). Next, a surgical procedure is performed to replace or repair the heart H. As examples, the cardiac surgery performed may be coronary artery bypass graft (CABG), heart valve repair, heart valve replacement, surgical ventricular restoration, ventricular assist device implantation, or heart transplant. Next, the sensing device 12 is introduced through the surgical opening within the patient's chest and implanted within the pulmonary artery PA to post-operatively monitor the patient.

In the illustrated method, this is accomplished by first making a cut C through the wall of the pulmonary artery PA to expose the lumen L (shown in FIG. 3D) of the PA just distal to the intended implantation site (FIG. 3B). Preferably, at this point, no blood is flowing through the pulmonary artery PA, so that no blood perfuses from the cut C. Significantly, as a normal step in cardiac surgical procedure, the heart H of the patient will typically be arrested and the pulmonary artery PA bypassed through a heart-lung machine. Thus, the present method takes advantage of this necessary step to access the pulmonary artery PA through surgical means. After making the cut C through the wall of the pulmonary artery PA, a suture 38 is threaded through the two eyelets 36 of the sensing device 12 and the opposing ends of the suture 38 are tied to a pair of needles 40 (FIG. 3D). While the sensing device 12 remains outside of the pulmonary artery PA, the needles 40 are then inserted through the cut C in the pulmonary artery PA and pushed from the lumen L out through the vessel wall at locations on each side of the intended implantation site (FIG. 3D). The sensing device 12 is then inserted through the cut C and into the lumen of the pulmonary artery PA, and the exposed suture 38 is tied to affix the sensing device 12 at the implantation site within the lumen of the pulmonary artery PA (FIG. 3E). The cut C within the pulmonary artery PA is then closed using a standard suturing procedure.

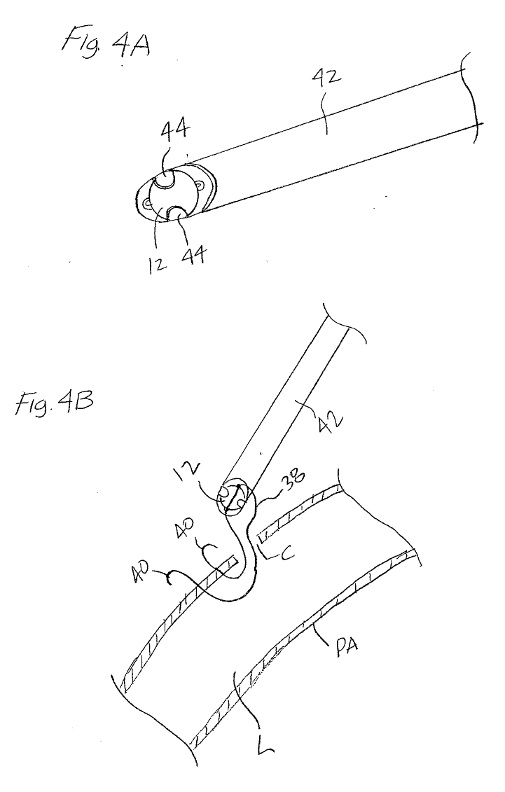

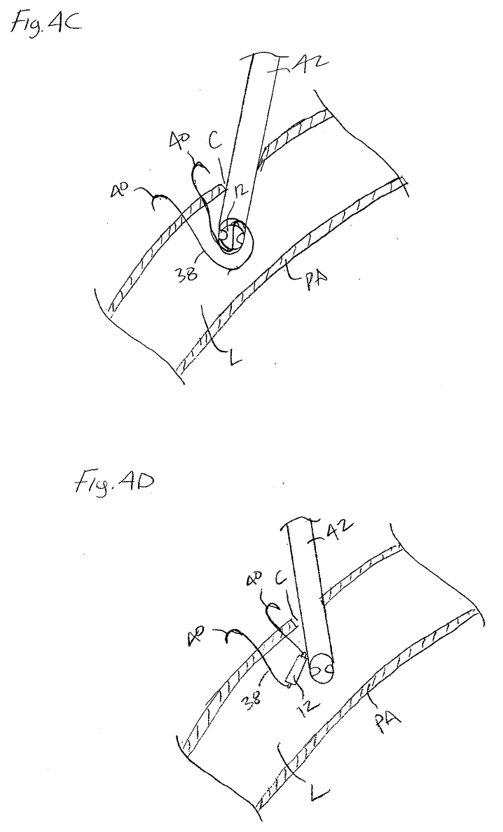

In an alternative method, a delivery device may be used to introduce the sensing device 12 into the pulmonary artery PA. For example, the sensing device 12 can be loaded into an introducer cannula 42, as shown in FIG. 4A. The introducer cannula 42 can be similar to cannulae typically used for introducing medical devices into blood vessels (e.g., during a valve replacement). The introducer cannula 42 has an open distal end, such that one side of the sensing device 12 is exposed. Any sensitive regions of the sensing device 12, such as the flexible pressure sensing face 34, can be protected by loading the sensing device 12, such that the sensitive regions face down towards the wall of the introducer cannula 42. Thus, any concern over damaging the sensitive regions of the sensing device 12 during its delivery into the pulmonary artery PA may be alleviated.

The introducer cannula 42 is preferably made of a thin-walled plastic tube, although a metal tube, such as one composed of stainless steel, can be used. The distal tip of the introducer cannula 42 may be soft in order to prevent or minimize injury to the vessel wall, but in alternative embodiments, may be rigid to facilitate its introduction through the vessel wall. The cannula 42 includes two opposing prongs 44 that function to hold and maintain the sensing device 12 within the cannula 42. Other suitable means for holding the sensing device 12 can also be used.

When using the cannula 42 to facilitate implantation of the sensing device 12, a suture 38 with needles 40 can be threaded through the two eyelets 36 of the sensing device 12, as previously discussed with respect to FIG. 3C. While the introducer cannula 42 and sensing device 12 remain outside of the pulmonary artery PA, the needles 40 are then inserted through the cut C in the pulmonary artery PA and pushed from the lumen L out through the vessel wall at locations on each side of the intended implantation site (FIG. 4B). The distal end of the introducer cannula 42, along with the sensing device 12, is then inserted through the cut C and into the lumen L of the pulmonary artery PA (FIG. 4C). The sensing device 12 is then released from the introducer cannula 42 (e.g., by sliding a plunger (not shown) through the introducer cannula 42 to release the sensing device 12 from the force applied by the prongs 44) (FIG. 4D), and the exposed suture 38 is tied to affix the released sensing device 12 at the implantation site within the lumen of the pulmonary artery PA in the same manner illustrated in FIG. 3E.

In an alternative method illustrated in FIG. 5, a clamp 46 may be used to isolate a region of the pulmonary artery PA from the blood flow. In particular, while blood is flowing through the pulmonary artery PA, the clamp 46 is clamped over a lateral portion of the pulmonary artery PA, thereby providing an isolated region 48 of the pulmonary artery PA through which no blood flows, and an open region 50 through blood flows. A cut can then be formed through the wall of the isolated region 48 without risk of blood leakage, and the sensing device 12 can then be implanted within the isolated region of the pulmonary artery PA using either of the implantation techniques described above with respect to FIGS. 3A-3E or FIGS. 4A-4D. Thus, it can be appreciated that this clamping technique allows the sensing device 12 to be implanted within the pulmonary artery PA without arresting the heart or otherwise bypassing the blood through a heart-lung machine if such steps are not required by the intended surgical procedure to be performed.

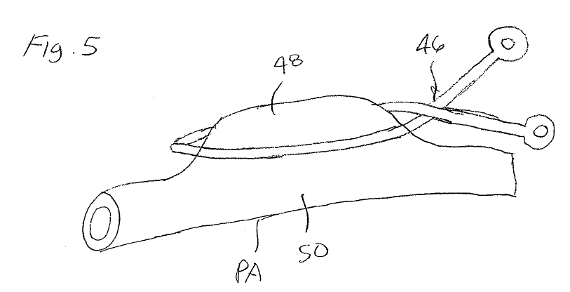

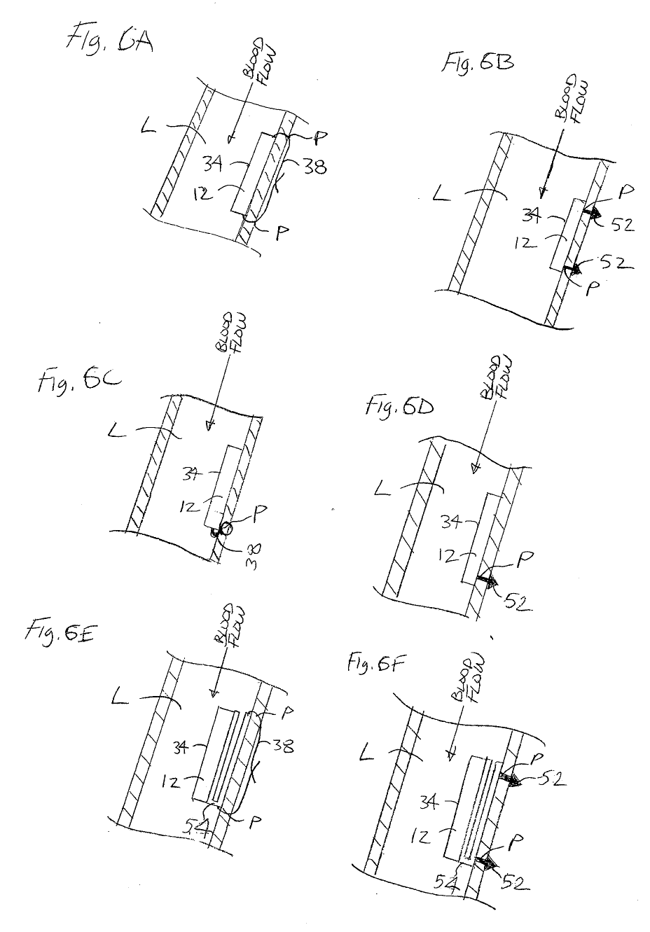

Referring now to FIGS. 6A-6F, various manners of affixing the sensing device 12 inside the pulmonary artery PA using the afore-described implantation techniques will be described. In FIG. 6A, the sensing device 12 is shown affixed to the wall of the pulmonary artery PA at two points P via a suture 38. The sensing device 12 is secured to the vessel wall, such that the pressure transferring face 34 of the sensing device 12 faces away from the vessel wall towards the lumen of the pulmonary artery PA and is exposed to the blood flow, while the opposite face of the sensing device 12 contacts the vessel wall. This design minimizes any potential disturbance to the blood flow within the pulmonary artery PA. A similar concept is illustrated in FIG. 6B, where barbs 52, instead of a suture 38, are used to affix the sensing device 12 to the vessel wall at two points P. Alternatively, other types of medical securing mechanisms, such as staples or screws, can be used to affix the sensing device 12 to the vessel wall.

In FIG. 6C, the sensing device 12 is shown affixed to the wall of the pulmonary artery PA at a single distal point P via a suture 38. Notably, any penetration through a vessel wall may induce cell proliferation over the pressure transferring face 34 of the sensing device 12. Since cell proliferation is known to propagate with the blood flow, affixing the sensing device 12 at the distal point P will significantly reduce any cell growth over the pressure transferring face 34. A similar concept is illustrated in FIG. 6D, where a barb 52, instead of a suture 38, is used to affix the sensing device 12 to the vessel wall at the distal point P.

In FIG. 6E, the sensing device 12 is shown mounted to a frame 54, which is affixed to the wall of the pulmonary artery PA at two points P via suture 38. In this affixation concept, the frame 54 is used to maintain the sensing device 12 away from the vessel wall, thereby minimizing any proliferation of tissue growth over the pressure transferring face 34 of the sensing device 12. A similar concept is illustrated in FIG. 6F, where barbs 52, instead of a suture 38, is used to affix the sensing device 12 to the vessel wall at two points P.

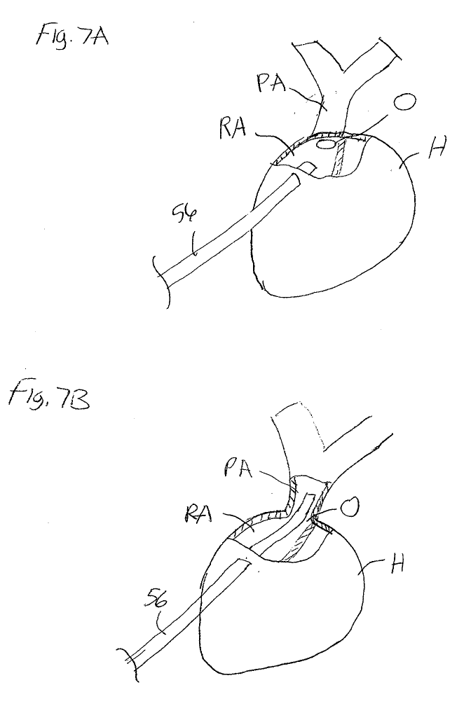

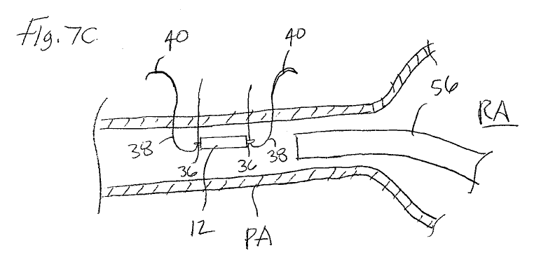

Although the previous implantation techniques introduce the sensing device 12 through a cut formed in the vessel wall of the pulmonary artery, an alternative implantation method may be employed without cutting the vessel wall of the pulmonary artery while still taking advantage of the surgical procedure performed on the heart. In particular, access to the pulmonary artery PA may be provided through the wall of the heart H, as illustrated in FIGS. 7A and 7B. In this method, the opening within the right atrium RA used to bypass the flow of blood through a heart-lung machine can advantageously be used to access to the pulmonary artery PA, so that no additional openings within the patient need be made.

As shown in FIG. 7A, a flexible catheter 56 is introduced through the wall of the heart H and into the right atrium RA. The distal end of the catheter 56 is then advanced from the right atrium RA into the ostium O of the pulmonary artery PA, so that it resides within the pulmonary artery PA, as shown in FIG. 7B. These steps can be accomplished while the heart H is beating and pumping blood, since no cut will be made in the pulmonary artery PA. Notably, the flow of blood from the right atrium RA through the pulmonary artery PA will aid in the navigation of the catheter 56 from the right atrium RA into the ostium O of the pulmonary artery PA. Optionally, a floating balloon catheter, e.g., a Swan Ganz catheter (not shown), which is designed to float with the blood flow to the pulmonary artery PA, can be used. In this case, the catheter 56 can be introduced through the balloon catheter into the pulmonary artery PA, or a guide wire can be introduced through the balloon catheter, and then the catheter 56 can be exchanged with the balloon catheter over the guide wire. Alternatively, the catheter 56 can be pre-shaped to aid its navigation from the right atrium RA to the pulmonary artery PA.

After the distal end of the catheter 56 is properly located within the pulmonary artery PA, the sensing device 12 can be affixed to the vessel wall. In the illustrated method, one or more of the eyelets 36 of the sensing device 12 are disposed outside of the catheter 56. In this case, the eyelet 56 can be flapped from the outside of the pulmonary artery PA. That is, the sensing device 12 is positioned at the desired implantation site and placed against the vessel wall, and because the low blood pressure vessel wall is relatively thin, it will deform, thereby allowing the physician to feel the contour of the sensing device 12, including the eyelets 36. The sensing device 12 can then be affixed to the vessel wall via the eyelets 36 using a suture 38 and needle 40 in a standard manner, as illustrated in FIG. 7C. Optionally, rather than suturing the sensing device 12 to the wall of the pulmonary artery PA, the sensing device 12 can be provided with barbs or staples, which can be covered by the catheter 56, but then exposed and pushed through the vessel wall after the sensing device 12 is released from the catheter 56.

The method described with respect to FIGS. 7A-7C can advantageously be performed as an adjunct to cardiac surgery wherein the heart is arrested and the blood is bypassed through a heart-lung machine. In this case, the sensing device 12 may be implanted within the pulmonary artery PA either before or after the cardiac surgery.

For example, the sensing device 12 may initially be implanted within the pulmonary artery PA in the manner described with respect to FIGS. 7A-7C, after which the delivery catheter 56 can be exchanged with a bypass cannula, the heart arrested, and then the cannula connected to a heart-lung machine to bypass the blood. The surgical procedure can then be performed to repair or replace an anatomical structure within the heart. Alternatively, the same cannula can be used to deliver the sensing device 12 and to bypass the blood through the heart-lung machine, thereby obviating the need to exchange instruments.

As another example, the bypass cannula can initially be introduced through the heart wall into the right atrium RA, the heart arrested, and then the cannula connected to the heart-lung machine to bypass the blood. The surgical procedure can then be performed to repair or replace an anatomical structure within the heart, after which the cannula can be exchanged with the delivery catheter 56, and the heart restarted. The sensing device 12 may then be implanted within the pulmonary artery PA in the manner described with respect to FIGS. 7A-7C. Again, alternatively, the same cannula can be used to deliver the sensing device 12 and to bypass the blood through the heart-lung machine, thereby obviating the need to exchange instruments.

While the sensing device 12 has been illustrated and described as being implanted within the pulmonary artery PA, it should be appreciated that the sensing device 12 can be implanted in other blood vessels of the patient's body, e.g., the vena cava, pulmonary vein, coronary sinus, aorta, sub-clavian artery, iliac artery, and carotid artery. While the inventive method lends itself well to the implantation of the sensing device 12 in blood vessels, it should be appreciated that the sensing device 12 can be implanted as an adjunct to surgery in other anatomical vessels, such as the esophagus, intestine, trachea, bronchial tubes, etc. In addition, the sensing device 12 can be implanted as an adjunct to surgery in anatomical cavities besides vessels, such as heart chambers (right atrium, right ventricle, left atrium, left ventricle, or the septum between the chambers), stomach, etc. In addition, while the afore-described implantation techniques take particular advantage of open surgical procedures, the sensing device 12 can be implanted as an adjunct to other types of surgical procedures, such as minimally invasive thoracoscopy typically used for CABG or repairing/replacing a heart valve or used for the treatment of other diseases, such as lung cancer. Lastly, while the present implantation techniques have been described with respect to wireless sensing devices, the same implantation techniques can be utilizes to implant wireless therapeutic devices (e.g., a drug releasing device or neuro-stimulator for treating arrhythmia, pain, or neurological disturbances or for stimulating the gastrointestinal system or urinary system) within the anatomical vessels or cavities of patients.

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed:

1. A method of implanting a physiological sensing device within a patient, the sensing device capable of wirelessly communicating within another device, the method comprising:
forming a surgical opening within the patient to expose an anatomical structure;
repairing or replacing an anatomical structure;
introducing the sensing device into a blood vessel of the patient via the surgical opening; and
affixing the sensing device within the blood vessel, wherein the entire sensing device is contained within the blood vessel.

2. The method of claim 1, wherein the sensing device comprises a pressure sensor.

3. The method of claim 2, wherein the sensing device is configured for measuring a full pressure waveform within the blood vessel.

4. The method of claim 1, wherein the sensing device comprises one or more of an accelerometer, a wall motion sensor, a flow sensor, temperature sensor, oxygen sensor, glucose sensor, coagulation sensor, an electrical activity sensor, and pH sensor.

5. The method of claim 1, wherein the sensing device comprises a processor for processing physiological information sensed by the sensing device.

6. The method of claim 5, wherein the processor is configured for estimating one or more of blood velocity, stroke volume, and cardiac output.

7. The method of claim 1, wherein the sensor is capable of wirelessly communicating with the other device using one or more of acoustic energy, electromagnetic energy, or magnetic energy.

8. The method of claim 1, wherein the other device is an external device.

9. The method of claim 1, wherein the anatomical structure comprises a heart or a portion thereof.

10. The method of claim 9, wherein repairing or replacing the anatomical structure comprises performing one or more of a coronary artery bypass graft installation, heart valve repair, heart valve replacement, surgical ventricular restoration, ventricular assist device implantation, and heart transplant.

11. The method of claim 1, wherein the blood vessel is a pulmonary artery.

12. The method of claim 1, wherein the blood vessel is one of a vena cava, pulmonary vein, coronary sinus, aorta, sub-clavian artery, iliac artery, and carotid artery.

13. The method of claim 1, wherein introducing the sensing device within the blood vessel comprises forming an opening through the wall of the blood vessel, and inserting the sensing device through the wall opening into the lumen of the blood vessel.

14. The method of claim 1, wherein introducing the sensing device within the blood vessel comprises introducing a cannula with the sensing device through the wall of the blood vessel, and releasing the sensing device from the cannula within the lumen of the blood vessel.

15. The method of claim 1, wherein the sensing device is introduced into the blood vessel without forming an opening through the wall of the blood vessel.

16. The method of claim 15, wherein the sensing device is introduced through an ostium of the blood vessel.

17. The method of claim 16, wherein the sensing device is introduced through the ostium of the blood vessel from a chamber of the heart.

18. The method of claim 1, wherein the sensing device is affixed within the blood vessel using at least one of a suture, barb, staple, and screw.

19. The method of claim 1, wherein the implanted sensing device senses a physiological parameter to monitor the anatomical structure.

20. A method of implanting a wireless device within a patient, the device capable of wirelessly communicating within another device, the method comprising:
forming a surgical opening in the patient to expose an anatomical structure;
repairing or replacing the anatomical structure;
introducing the wireless device into an anatomical cavity of the patient via the surgical opening; and
affixing the wireless device within the anatomical cavity, wherein the entire device is contained within the anatomical cavity.

21. The method of claim 20, wherein the wireless device is a sensing device.

22. The method of claim 20, wherein the wireless device is a therapeutic device.

23. The method of claim 20, wherein the wireless device is capable of wirelessly communicating with the other device using one or more of acoustic energy, electromagnetic energy, or magnetic energy.

24. The method of claim 20, wherein the other device is an external device.

25. The method of claim 20, wherein the anatomical structure is a heart or a portion thereof.

26. The method of claim 20, wherein the anatomical cavity is a blood vessel.

27. The method of claim 20, wherein the anatomical cavity is a heart chamber.

28. The method of claim 20, wherein introducing the wireless device within the anatomical cavity comprises forming an opening through a wall surrounding the anatomical cavity, and inserting the wireless device through the wall opening into the anatomical cavity.

29. The method of claim 20, wherein introducing the wireless device within the anatomical cavity comprises introducing a cannula with the wireless device through a wall surrounding the anatomical cavity, and releasing the wireless device from the cannula within the anatomical cavity.

30. The method of claim 20, wherein the wireless device is affixed within the blood vessel using at least one of a suture, barb, staple, and screw.

31. A method of implanting a device within a patient, the device capable of wirelessly communicating within another device, the method comprising:
forming an opening within the patient to expose a heart of the patient;
repairing or replacing an anatomical structure of the heart;
introducing the wireless device through the opening into a blood vessel; and
affixing the wireless device within the blood vessel, wherein the entire wireless device is contained within the blood vessel.

32. The method of claim 31, wherein the wireless device is a sensing device.

33. The method of claim 31, wherein the wireless device is a therapeutic device.

34. The method of claim 31, wherein the wireless device is capable of wirelessly communicating with the other device using one or more of acoustic energy, electromagnetic energy, or magnetic energy.

35. The method of claim 31, wherein the other device is an external device.

36. The method of claim 31, wherein repairing or replacing the anatomical structure comprises performing one or more of a coronary artery bypass graft installation, heart valve repair, heart valve replacement, surgical ventricular restoration, ventricular assist device implantation, and heart transplant.

37. The method of claim 31, wherein the blood vessel is a pulmonary artery.

38. The method of claim 31, wherein introducing the wireless device within the blood vessel comprises forming an opening through the wall of the blood vessel, and inserting the wireless device through the wall opening into the lumen of the blood vessel.

39. The method of claim 31, wherein introducing the wireless device within the blood vessel comprises introducing a cannula with the wireless device through the wall of the blood vessel, and releasing the wireless device from the cannula within the lumen of the blood vessel.

40. The method of claim 31, wherein the wireless device is introduced into the blood vessel without forming an opening through the wall of the blood vessel.

41. The method of claim 40, wherein the wireless device is introduced through an ostium of the blood vessel.

42. The method of claim 41, wherein the wireless device is introduced through the ostium of the blood vessel from a chamber of the heart.

43. The method of claim 42, further comprising forming an opening within the heart to access the chamber, and introducing the wireless device into the chamber of the heart via the heart opening.

44. The method of claim 43, further comprising arresting the heart and conveying blood between the chamber of the arrested heart and a machine via the heart opening.

45. The method of claim 31, wherein the wireless device is affixed within the blood vessel using at least one of a suture, barb, staple, and screw.
